(19) United States
(12) Patent Application Publication
(10) Pub. No.: US 2026/0296361 A1
(43) Pub. Date: Oct. 1, 2026

(54) THREE-POINT SEAT BELT DEVICE FOR VEHICLE

(71) Applicant: SUBARU CORPORATION, Tokyo (JP)

(72) Inventor: Koichi MASHIKO, Tokyo (JP)

(21) Appl. No.: 19/562,055

(22) Filed: Mar. 10, 2026

(30) Foreign Application Priority Data
Mar. 28, 2025 (JP) 2025-055588

(51) Int. Cl. B60R 22/02; B60R 22/18; B60R 22/34

(52) U.S. Cl. CPC B60R 22/023; B60R 22/18; B60R 22/34; B60R 2022/1806

(57) ABSTRACT

A three-point seat belt device for a vehicle includes a seat belt, a retractor, an inner tongue, an inner buckle, an outer support member, and an inner support member. The retractor is configured to wind a first end out of ends of the seat belt. The seat belt passes through a tongue hole of the inner tongue, behind the outer support member, and behind the inner support member. A second end out of the ends of the seat belt is fixed to the inner buckle. The seat belt is configured to, when the inner tongue is coupled to the inner buckle, form an annular portion that is annular around a waist of an occupant sitting in a sitting position of a seat between the inner buckle and the outer support member. The outer support member and the inner support member are located inward of the annular portion.

### CROSS-REFERENCE TO RELATED APPLICATIONS

The present application claims priority from Japanese Patent Application No. 2025-055588 filed on Mar. 28, 2025, the entire contents of which are hereby incorporated by reference.

### BACKGROUND

The disclosure relates to a three-point seat belt device for a vehicle.

In a vehicle, a seat belt device is used to protect an occupant sitting on a seat. As the seat belt device, a three-point seat belt device that supports a first shoulder out of the left and right shoulders of the occupant and both the left and right sides of the waist is employed.

In the three-point seat belt device, generally, a first end out of both ends of a seat belt is coupled to a retractor provided on a side surface or the like of a vehicle body on a first side out of both left and right sides of a sitting position of a seat such that the seat belt can be wound, and a second end out of both ends of the seat belt is fixed to the vehicle body on the first side out of both the left and right sides of the sitting position of the seat. The first end and the second end of the seat belt are attached to the first side out of both the left and right sides of the sitting position of the seat. An inner buckle is fixed to the vehicle body on a second side out of both the left and right sides of the sitting position of the seat. An inner tongue through which the seat belt passes is coupled to the inner buckle such that the seat belt is stretched in front of the occupant sitting in the sitting position of the seat. The seat belt includes a lap belt portion stretched in front of the waist of the occupant along a right-left direction of the vehicle, and a shoulder belt portion stretched obliquely in front of the upper body from a position of the waist of the occupant on the second side to the shoulder on the first side. When the vehicle comes into a front collision with another vehicle or the like, the body of the occupant will move forward. The seat belt can protect the occupant by suppressing forward movement of the occupant.

Japanese Unexamined Patent Application Publication No. 2004-130920 discloses a seat belt device including a lap belt portion and a hip belt portion. The inner side of the hip belt portion is not coupled to the lap belt portion, and is fixed to a seat by an inner anchor.

Japanese Unexamined Patent Application Publication No. 2016-097869 discloses that an energy absorbing plate is provided between a lap belt anchor and a floor. The energy absorbing plate is deformed along with forward movement of the waist of an occupant in the event of a collision.

### SUMMARY

An aspect of the disclosure provides a three-point seat belt device for a vehicle. The three-point seat belt device includes a seat belt, a retractor, an inner tongue, an inner buckle, an outer support member, and an inner support member. The seat belt is configured to be stretched in front of an occupant sitting in a sitting position of a seat of the vehicle. The retractor is provided on a first side out of left and right sides of the vehicle relative to the sitting position of the seat and is configured to wind a first end out of ends of the seat belt. The inner tongue has a tongue hole. The inner buckle is detachably coupled to the inner tongue. The outer support member is fixed at a position that is on the first side relative to the sitting position and is lower than the sitting position of the seat. The inner support member is fixed at a position that is on a second side out of the left and right sides of the vehicle relative to the sitting position and is lower than the sitting position of the seat. The seat belt passes through the tongue hole of the inner tongue, behind the outer support member, and behind the inner support member. A second end out of the ends of the seat belt is fixed to the inner buckle. The seat belt is configured to, when the inner tongue is coupled to the inner buckle, form an annular portion that is annular around a waist of the occupant sitting in the sitting position of the seat between the inner buckle and the outer support member. The outer support member and the inner support member are located inward of the annular portion.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic explanatory diagram of an example of a state in which a vehicle comes into a front collision;

FIG. 2 is a schematic explanatory diagram of a sitting state of occupants on a rear seat of the vehicle in FIG. 1;

FIG. 3 is a schematic configuration diagram of an example of a three-point seat belt device for a vehicle according to an embodiment of the disclosure;

FIG. 4 is a schematic explanatory top view of a state of an occupant using the three-point seat belt device in FIG. 3 before a front collision;

FIG. 5 is a schematic explanatory top view of a state of the occupant using the three-point seat belt device in FIG. 3 after the front collision;

FIG. 6 is a schematic explanatory side view of the occupant in the state before the front collision;

FIG. 7 is a schematic explanatory diagram of a state in which the occupant in FIG. 6 has moved forward due to the front collision;

FIG. 8 is a schematic explanatory diagram of a state in which the upper body of the occupant in FIG. 6 has fallen forward due to the front collision;

FIG. 9 is a schematic perspective view illustrating the configuration of an example of a movement mechanism in FIG. 3;

FIG. 10 is a rear end view of a plate in FIG. 9;

FIG. 11 is a schematic perspective view of the movement mechanism in FIG. 9 after a pre-tension winding operation has been performed;

FIG. 12 is a schematic perspective view of the movement mechanism in FIG. 9 after the front collision of the vehicle;

FIG. 13 is a schematic explanatory top view of the occupant in FIG. 15;

FIG. 14 is a schematic explanatory top view of the occupant in FIG. 17;

FIG. 15 is a schematic explanatory diagram of a three-point seat belt device according to a comparative example in a state before a front collision;

FIG. 16 is a schematic explanatory diagram of a state in which the occupant in FIG. 15 has moved forward due to the front collision; and

FIG. 17 is a schematic explanatory diagram of a state in which the upper body of the occupant in FIG. 15 has fallen forward due to the front collision.

### DETAILED DESCRIPTION

Even when a three-point seat belt device is used, the wearing state of the seat belt changes depending on movement of the body of an occupant. When the distance from an inner buckle to the waist of the occupant increases as a result of the movement of the body, the seat belt is likely to be displaced upward from the position in front of the waist of the occupant and ride on the waist. When the shoulder belt portion of the seat belt rides on the waist, the input to the chest of the occupant when the upper body of the occupant falls forward thereafter increases.

It is desirable to provide a three-point seat belt device for a vehicle in which, even if an occupant moves in the event of a front collision of the vehicle, the wearing state of the seat belt is less likely to change from the state when the occupant has worn the seat belt.

Hereinafter, an embodiment of the disclosure will be described with reference to the drawings.

### Outline

The embodiment of the disclosure exemplifies a three-point seat belt device in which, even if an occupant moves in the event of a front collision of a vehicle 1, the wearing state of the seat belt is less likely to change from the state when the occupant has worn the seat belt.

The three-point seat belt device for a vehicle according to the embodiment of the disclosure includes an outer support member and an inner support member in addition to a seat belt, a retractor, an inner tongue, and an inner buckle. The outer support member is fixed at a position that is on a first side in a right-left direction relative to a sitting position of a seat and is lower than the sitting position of the seat. The inner support member is fixed at a position that is on a second side in the right-left direction relative to the sitting position and is lower than the sitting position of the seat. The first side is a side on which the retractor that winds the seat belt is provided. The second side is a side opposite to the first side.

The seat belt passes through a tongue hole of the inner tongue, behind the outer support member, and behind the inner support member. A second end out of both ends of the seat belt is fixed to the inner buckle. When the inner tongue and the inner buckle are coupled to each other, the seat belt forms an annular portion that is annular around the waist of the occupant sitting in the sitting position of the seat between the inner buckle and the outer support member. The outer support member and the inner support member are located inward of the annular portion. The annular portion of the seat belt includes a lap belt portion of the seat belt.

Such an annular portion of the seat belt can rotate in conjunction with the movement of the occupant. By the rotation of the annular portion of the seat belt, the inner buckle is maintained at a position close to the side of the waist of the occupant who has moved forward (a position on the inner side of the waist). As a result, the seat belt may be stretched in front of the occupant who has moved forward in the same state as that when the occupant has not moved forward. The seat belt, particularly a shoulder belt portion of the seat belt that is stretched obliquely in front of the upper body of the occupant, is less likely to be displaced upward from a position in front of the waist of the occupant when the occupant has worn the seat belt. When the shoulder belt portion of the seat belt moves onto the waist and rides on the waist, the input of the shoulder belt portion to the chest of the occupant is likely to increase.

In the following embodiment, examples of the three-point seat belt device for a vehicle, the configuration of the three-point seat belt device, occupant protection by the three-point seat belt device, a movement mechanism for the inner buckle, and a comparative example will be described in order.

Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Description of Three-point Seat Belt Device for Vehicle

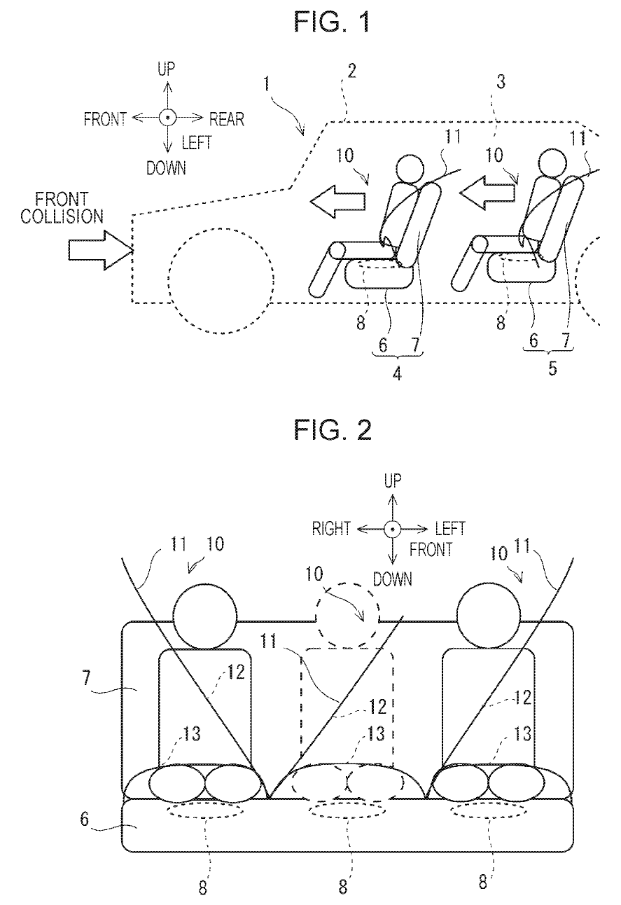

FIG. 1 is a schematic explanatory diagram of an example of a state in which the vehicle 1 comes into a front collision. FIG. 2 is a schematic explanatory diagram of a sitting state of occupants on a rear seat 5 of the vehicle 1 in FIG. 1. In the following, terms "front," "rear," "left," "right," "up," and "down" are used based on FIG. 1. A vehicle width direction of the vehicle 1 is a right-left direction.

As illustrated in FIG. 1, the vehicle 1 includes a vehicle body 2. A plurality of seats on which occupants sit is provided in a cabin 3 of the vehicle body 2. In the vehicle 1 in FIG. 1, a front seat 4 and the rear seat 5 are illustrated. The front seat 4 or the rear seat 5 includes a seat portion 6 and a back portion 7. A sitting position 8 where the waist of the occupant sits is set in the seat portion 6. The back portion 7 is inclined rearward from the seat portion 6 behind the sitting position 8 in the vehicle 1. The angle of the back portion 7 may be changed. As illustrated in FIG. 2, the rear seat 5 extends in the right-left direction of the vehicle 1, and a plurality of sitting positions 8 where a plurality of occupants can sit side by side is set. Three sitting positions 8 are set in the rear seat 5 in FIG. 2. The sitting position 8 is generally recessed in the seat portion 6 of the seat.

Since the vehicle 1 travels on a road, the vehicle 1 may come into a front collision with another vehicle or the like. When the vehicle 1 comes into a front collision, as illustrated in FIG. 1, a force acts on the occupant sitting on the seat to move the occupant forward. Therefore, a seat belt device 10 is provided for each sitting position 8 of the seat. As illustrated in FIGS. 1 and 2, a seat belt 11 of the seat belt device 10 is stretched in front of the occupant to suppress the forward movement of the occupant. The occupant can be protected from the front collision of the vehicle 1.

The seat belt device 10 illustrated in FIGS. 1 and 2 is a three-point seat belt device 10. In this case, the seat belt 11 includes a lap belt portion 13 stretched in front of the waist of the occupant along the right-left direction of the vehicle 1, and a shoulder belt portion 12 stretched obliquely in front of the upper body of the occupant. The shoulder belt portion 12 is stretched obliquely from the shoulder of the occupant on the first side to the waist on the second side.

Even when such a three-point seat belt device 10 is used, a great input may be applied to the occupant. For example, in the case of a child or the like having a small body, the body may move greatly as compared with an adult.

First, the support points of the seat belt 11 on both sides in the right-left direction relative to the sitting position 8 have a width in consideration of the case where an adult sits on the seat. As a result, when a child or the like having a small body sits on the seat, the seat belt 11 is likely to have a surplus on the left and right sides of the body as in the example of FIG. 2. The body of a child or the like is likely to move to the left and right on the inner side of the seat belt 11.

Secondly, for example, in the case of the left-end sitting position 8 or the right-end sitting position 8 of the three-seater rear seat 5, a first end out of both ends of the seat belt 11 may be fixed to the vehicle body 2 at a position away from the sitting position 8 in the right-left direction as compared with a second end on the second side near an inner buckle 19. A wheel house or the like is provided on a side surface of the vehicle body 2, and the sitting position 8 may be set in the rear seat 5 to avoid the wheel house. In this case, the distance from the left-end sitting position 8 of the rear seat 5 to the left side surface of the vehicle body 2 and the distance from the right-end sitting position 8 of the rear seat 5 to the right side surface of the vehicle body 2 increase. For example, the end of the lap belt portion 13 of the seat belt 11 on the second side relative to the left sitting position 8 in FIG. 2 is farther away from the sitting position 8 than the end on the first side. The distance from the sitting position 8 to the side surface of the vehicle body 2 contributes to an increase in safety against a side collision.

Therefore, for example, when the vehicle 1 comes into a front collision in a state in which a child or the like is seated with the seat belt 11 in the left-end sitting position 8 of the rear seat 5, the body of the child or the like may move greatly forward on the inner side of the seat belt 11. The body of the child or the like moving forward is supported by the lap belt portion 13. Therefore, the body of the child or the like who has moved forward may move toward the center position between the left and right support points of the sitting position 8, that is, toward the first side in the right-left direction. As a result, the wearing state of the seat belt 11 relative to the body of the child or the like who has greatly moved forward may differ from the state when the child or the like has worn the seat belt 11.

For example, the inner buckle 19 maintains the original position where the inner buckle 19 is fixed to the vehicle body 2 even when the waist of the occupant moves forward. As a result, the distance from the inner buckle 19 to the waist of the occupant who has moved forward increases. If the distance increases, the seat belt 11, particularly the shoulder belt portion 12, is likely to be displaced upward from the position in front of the waist of the occupant when the occupant has worn the seat belt 11. When the shoulder belt portion 12 of the seat belt 11 moves onto the waist and rides on the waist, the input of the shoulder belt portion 12 to the chest of the occupant may increase.

In the three-point seat belt device 10 for the vehicle 1, even if the occupant moves in the event of the front collision of the vehicle 1, it is desirable that the wearing state of the seat belt 11 be less likely to change from the state when the occupant has worn the seat belt 11.

### Example of Configuration of Three-point Seat Belt Device in Embodiment of Disclosure

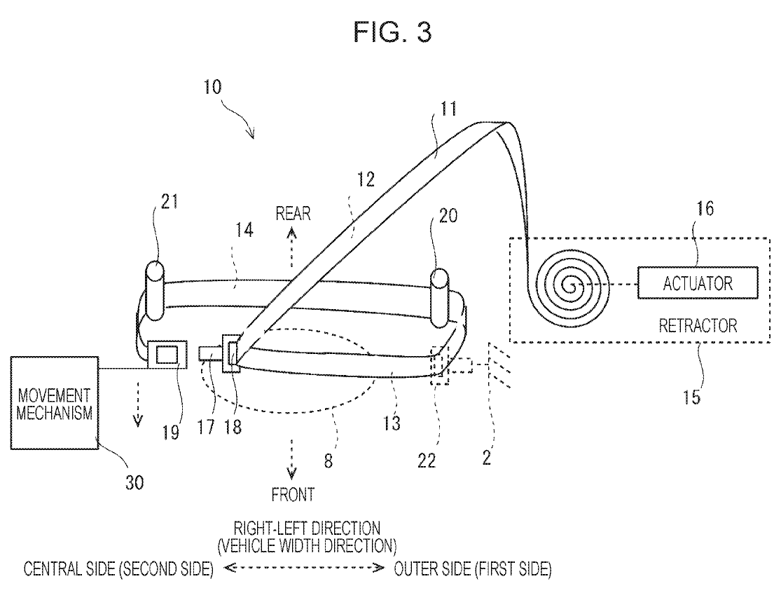

FIG. 3 is a schematic configuration diagram of an example of the three-point seat belt device 10 for the vehicle 1 according to the embodiment of the disclosure.

The three-point seat belt device 10 in FIG. 3 is provided, for example, in the left-end sitting position 8 of the three-seater rear seat 5 in FIG. 2. The three-point seat belt device 10 for the right-end sitting position 8 of the three-seater rear seat 5 in FIG. 2 may be bilaterally symmetrical to that in FIG. 3.

In FIG. 3, the first side in the right-left direction relative to the right-end sitting position 8 of the rear seat 5 is an outer side in the vehicle width direction. The second side is a central side in the vehicle width direction.

The three-point seat belt device 10 in FIG. 3 includes the seat belt 11, a retractor 15, an inner tongue 17, the inner buckle 19, an outer support member 20, an inner support member 21, and a movement mechanism 30 for the inner buckle 19.

The seat belt 11 is stretched in front of the occupant sitting in the sitting position 8 of the seat of the vehicle 1. The seat belt 11 is formed by plain-weaving, for example, nylon fibers or polyester fibers into a long belt shape. The first end out of both ends of the seat belt 11 is attached to the retractor 15.

The retractor 15 includes an actuator 16 that winds the seat belt 11 from the first end. The retractor 15 can perform a pre-tension winding operation for winding the seat belt 11 with a strong force by the actuator 16 in the event of a front collision of the vehicle 1. The retractor 15 is fixed to, for example, the inside of a B-pillar on the side surface of the cabin 3 of the vehicle body 2. In this case, the retractor 15 is provided on the side surface of the vehicle body 2 of the vehicle 1 on the first side in the right-left direction of the vehicle 1 relative to the sitting position 8 of the seat. An opening for drawing out the seat belt 11 from the inside of the B-pillar may be formed in the upper portion of the B-pillar. An outer tongue 22 (not illustrated) may be provided in the opening of the B-pillar. Thus, the seat belt 11 can extend from the upper side of the occupant sitting on the seat toward the shoulder.

The inner tongue 17 is a high-strength metal plate having a substantially flat plate shape. The inner tongue 17 has a tongue hole 18 through which the seat belt 11 passes, and a portion that is attached to and detached from the inner buckle 19.

The inner buckle 19 has a groove into which the inner tongue 17 can be inserted, and the inner tongue 17 is detachably coupled to the inner buckle 19. The inner buckle 19 may have a push button for decoupling the inner tongue 17. When the push button is operated, the inner tongue 17 and the inner buckle 19 are decoupled from each other. The inner tongue 17 can be pulled out from the inner buckle 19.

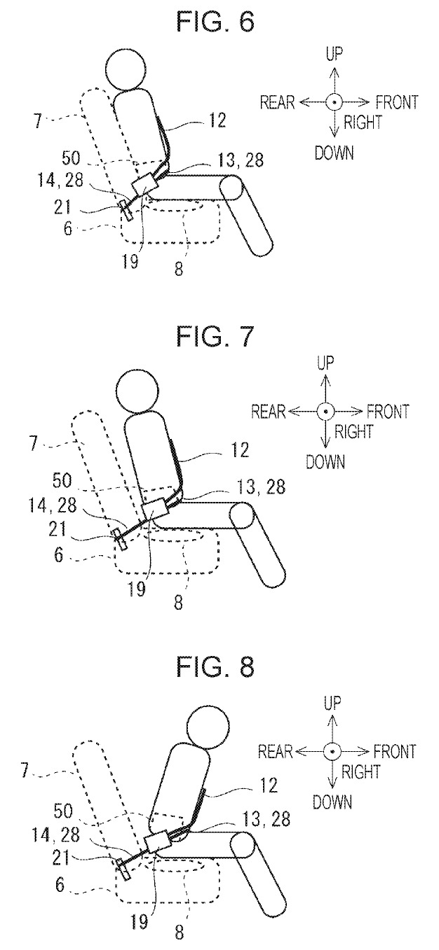

The outer support member 20 and the inner support member 21 are high-strength substantial metal rods. As illustrated in FIG. 6, the outer support member 20 and the inner support member 21 are fixed to the vehicle body 2 behind the sitting position 8 of the seat. The inner support member 21 is fixed to the vehicle body 2 below the seat at a position that is on the second side in the right-left direction relative to the sitting position 8 of the seat and is lower than the sitting position 8 of the seat in a rearward and downward direction. The outer support member 20 is fixed to the vehicle body 2 below the seat at a position that is on the first side in the right-left direction relative to the sitting position 8 of the seat and is lower than the sitting position 8 of the seat in a rearward and downward direction. The outer support member 20 and the inner support member 21 may be fixed to a frame of the seat attached to the vehicle body 2. The outer support member 20 or the inner support member 21 may be formed in a shape of a tongue plate having a tongue hole through which the seat belt 11 passes, instead of the substantial rod shape. The outer support member 20 or the inner support member 21 in the shape of a tongue plate may be swingably or non-swingably fixed to the vehicle body.

The movement mechanism 30 is fixed to the vehicle body 2 on the second side in the right-left direction of the vehicle 1 relative to the sitting position 8. The inner buckle 19 is attached to the movement mechanism 30. The movement mechanism 30 supports the inner buckle 19 such that the inner buckle 19 is movable relative to the vehicle body 2 of the vehicle 1 on the second side of the sitting position 8. The movement mechanism 30 may support the inner buckle 19 such that the inner buckle 19 is movable along a front-rear direction. Details of the movement mechanism 30 will be described later.

The seat belt 11 whose first end is coupled to the retractor 15 passes through the tongue hole 18 of the inner tongue 17, behind the outer support member 20, and behind the inner support member 21. The second end of the seat belt 11 is fixed to the inner buckle 19.

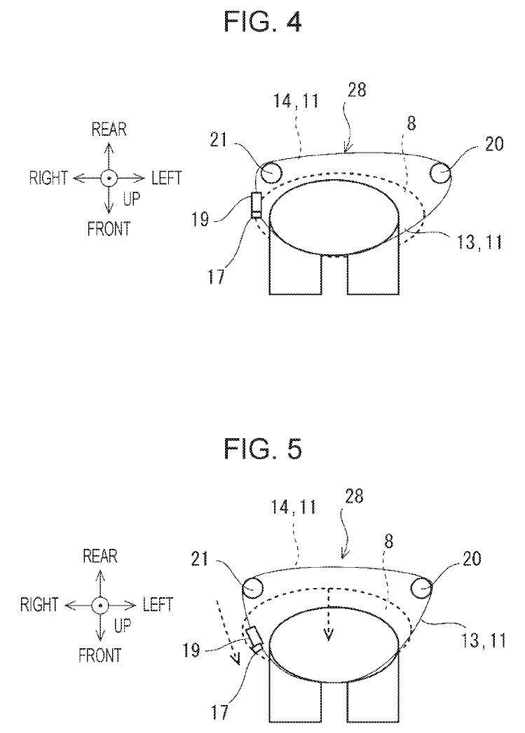

Therefore, as illustrated in FIG. 4, when the inner tongue 17 is coupled to the inner buckle 19, the seat belt 11 has an annular shape around the waist of the occupant sitting in the sitting position 8 of the seat between the inner buckle 19 and the outer support member 20. The outer support member 20 and the inner support member 21 together with the occupant are located inward of an annular portion 28 of the seat belt 11. In this case, the seat belt 11 has a back belt portion 14 in addition to the shoulder belt portion 12 and the lap belt portion 13. The back belt portion 14 is a portion stretched along the right-left direction behind the outer support member 20 and the inner support member 21, that is, behind the waist of the occupant. The annular portion 28 of the seat belt 11 is constituted by the lap belt portion 13 and the back belt portion 14.

### Example of Occupant Protection by Three-point Seat Belt Device in Embodiment of Disclosure

Next, occupant protection by the three-point seat belt device 10 according to the embodiment of the disclosure will be described with reference to FIG. 4 to FIG. 8.

The three-point seat belt device 10 according to the embodiment of the disclosure basically suppresses the forward movement of the occupant by the shoulder belt portion 12 and the lap belt portion 13 of the seat belt 11 stretched in front of the occupant sitting in the sitting position 8 of the seat. Since the annular portion 28 of the seat belt 11 is rotatable, the inner buckle 19 is maintained near the waist of the occupant who has moved forward.

First, an operation of the annular portion 28 of the seat belt 11 in the event of a front collision will be described.

FIG. 4 is a schematic explanatory top view of a state of the occupant using the three-point seat belt device 10 in FIG. 3 before the front collision.

The annular portion 28 of the seat belt 11 is constituted by the lap belt portion 13, the back belt portion 14, the inner buckle 19, and the inner tongue 17. The occupant sitting in the sitting position 8 of the seat, the outer support member 20, and the inner support member 21 are present inward of the annular portion 28.

When the vehicle 1 comes into the front collision, the occupant moves forward. FIG. 5 is a schematic explanatory top view of a state of the occupant using the three-point seat belt device 10 in FIG. 3 after the front collision. When the occupant moves forward, the annular portion 28 including the lap belt portion 13 stretched in front of the waist of the occupant is pulled forward due to the forward movement of the occupant while maintaining the annular shape. When the occupant starts to move forward, the distance from the waist of the occupant to the outer support member 20 and the inner support member 21 increases. Thus, the annular portion 28 is supported by the outer support member 20 and the inner support member 21, and the load of the occupant acts strongly on the annular portion 28. The annular portion 28 is brought into close contact with the occupant by the load of the occupant, and is less likely to be displaced relative to the occupant.

As illustrated in FIG. 5, the annular portion 28 of the seat belt 11 is strongly pulled in the moving direction of the occupant, and rotates in conjunction with the movement of the occupant. In particular, when the seat belt 11 is pre-tensioned as described later, the annular portion 28 of the seat belt 11 is substantially in close contact with the occupant before the occupant starts to move, and can rotate in conjunction with the movement of the occupant immediately after the occupant starts to move forward. The annular portion 28 can support, while rotating, the occupant who will move forward such that the occupant does not move forward.

As a result, the inner buckle 19 included in the annular portion 28 rotates together with the annular portion 28, and can be maintained at the position on the inner side of the waist of the occupant as illustrated in FIG. 5 relative to the occupant who has moved forward, similarly to the time when the occupant has worn the seat belt 11 as illustrated in FIG. 4. In particular, when the occupant is located in the left-end sitting position 8 or the right-end sitting position 8 of the three-seater rear seat 5 in FIG. 2, the distance from the sitting position 8 of the occupant to the outer support member 20 is larger than the distance from the sitting position 8 of the occupant to the inner buckle 19. In this case, the occupant may move in a forward and outward direction. Even when the occupant moves in the forward and outward direction, the annular portion 28 of the seat belt 11 is pulled in the forward and outward direction while rotating. As a result, the inner buckle 19 can be maintained at the position on the inner side of the waist of the occupant as illustrated in FIG. 5 relative to the occupant who has moved in the forward and outward direction.

Since the lap belt portion 13 of the annular portion 28 of the seat belt 11 is brought into close contact with the occupant by the load of the occupant and rotates without slipping relative to the occupant, the lap belt portion 13 is likely to remain at the position in front of the waist of the occupant similarly to the time when the occupant has worn the seat belt 11.

Next, occupant protection by the three-point seat belt device 10 as a whole will be described.

FIG. 6 is a schematic explanatory side view of the occupant in the state before the front collision. FIG. 6 illustrates the same state before the collision as in FIG. 4. The state before the front collision in FIG. 6 is realized by the occupant sitting on the seat and wearing the seat belt 11. The occupant draws out the seat belt 11 from the retractor 15 after sitting in the sitting position 8 of the seat, and couples, to the inner buckle 19, the inner tongue 17 through which the seat belt 11 passes. The seat belt 11 is stretched in front of the occupant sitting in the sitting position 8 of the seat. The annular portion 28 is formed in the seat belt 11.

Therefore, the lap belt portion 13 of the seat belt 11 is stretched between the inner tongue 17 coupled to the inner buckle 19 and the outer support member 20. As indicated by broken lines in FIG. 3, when the outer tongue 22 attached to the vehicle body 2 is provided forward of the outer support member 20, the lap belt portion 13 extends from the inner tongue 17 coupled to the inner buckle 19 to the outer tongue 22. The lap belt portion 13 is stretched in front of a pelvis 50 of the waist of the occupant sitting in the sitting position 8 of the seat.

The shoulder belt portion 12 of the seat belt 11 extends from the inner tongue 17 coupled to the inner buckle 19 toward the upper rear side of the shoulder of the occupant. Since the inner tongue 17 is located at the position on the inner side that is the second side of the waist of the occupant sitting in the sitting position 8 of the seat, the shoulder belt portion 12 is stretched obliquely in front of the upper body of the occupant from the position on the inner side that is the second side of the waist to the shoulder on the first side. The lower end of the shoulder belt portion 12 on the second side is located in front of the waist of the occupant. The lower end of the shoulder belt portion 12 passes in front of the pelvis 50 of the waist of the occupant.

As in an example of the inner support member 21 in FIG. 6, the substantially rod-shaped inner support member 21 and the substantially rod-shaped outer support member 20 are provided at positions lower than the sitting position 8 of the seat in the rearward and downward direction in a posture in which they are inclined rearward and upward. Therefore, when the annular portion 28 of the seat belt 11 rotates, the annular portion 28 can smoothly slide and rotate on the inner support member 21 and the outer support member 20 while maintaining the state in which the annular portion 28 is stretched on the inner support member 21 and the outer support member 20. When the back belt portion 14 slides on the inner support member 21 and the outer support member 20, the back belt portion 14 is less likely to be displaced upward or downward relative to the inner support member 21 and the outer support member 20. When the annular portion 28 rotates, the back belt portion 14 on which the load of the occupant acts is less likely to be displaced upward or downward on the inner support member 21 and the outer support member 20 and detached upward or downward from the inner support member 21 and the outer support member 20.

When the vehicle 1 comes into the front collision, the occupant moves forward. FIG. 7 is a schematic explanatory diagram of a state in which the occupant in FIG. 6 has moved forward due to the front collision. FIG. 7 illustrates the same state after the collision as in FIG. 5. The upper body and the waist of the occupant who has moved forward are separated forward from the back portion 7 of the seat. Since the lap belt portion 13 of the seat belt 11 is supported by the inner support member 21 and the outer support member 20, the lap belt portion 13 supports the occupant moving forward from the sitting position 8 of the seat. The waist of the occupant is maintained on the seat. The annular portion 28 of the seat belt 11 can maintain the position in front of the pelvis 50 of the waist of the occupant because the lap belt portion 13 rotates following the movement of the waist of the occupant and is less likely to slip relative to the waist.

The inner buckle 19 included in the annular portion 28 rotates in conjunction with the movement of the occupant by the rotation of the annular portion 28. As a result, the inner buckle 19 is maintained at the position on the inner side of the pelvis 50 of the waist of the occupant relative to the occupant moving forward similarly to the time when the occupant has worn the seat belt 11 in FIG. 6. Even when the occupant moves in the forward and outward direction, the inner buckle 19 can be maintained at the position on the inner side of the pelvis 50 of the waist of the occupant.

Since the inner buckle 19 is maintained at the position on the inner side of the pelvis 50 of the waist of the occupant, the shoulder belt portion 12 of the seat belt 11 is stretched obliquely in front of the upper body of the occupant in the same state as that when the occupant has worn the seat belt 11 in FIG. 6. That is, the shoulder belt portion 12 is stretched obliquely in front of the upper body of the occupant who has moved forward from the position on the inner side that is the second side of the waist of the occupant to the shoulder on the first side. The lower end of the shoulder belt portion 12 on the second side is maintained at the position on the inner side of the waist of the occupant. The lower end of the shoulder belt portion 12 can maintain the state in which it passes in front of the pelvis 50 of the waist of the occupant who has moved forward.

When the input to the vehicle 1 due to the front collision is great, the upper body of the occupant who has moved forward falls forward as illustrated in FIG. 8. FIG. 8 is a schematic explanatory diagram of the state in which the upper body of the occupant in FIG. 6 has fallen forward due to the front collision. In the embodiment of the disclosure, the inner buckle 19 is maintained at the position on the inner side of the waist of the occupant who has moved forward. Therefore, the shoulder belt portion 12 of the seat belt 11 is maintained in the state in which it is stretched in front of the pelvis 50 of the waist of the occupant who has moved forward. Even when the waist of the occupant moves forward, the seat belt 11, particularly the shoulder belt portion 12, is less likely to ride on the waist.

As a result, the shoulder belt portion 12 can support the upper body of the occupant who will fall forward while moving forward together with the pelvis 50 such that the occupant does not fall from the front side of the occupant. The shoulder belt portion 12 can reduce the occurrence of a state in which the upper body of the occupant who falls forward while moving forward bends over the pelvis 50. The shoulder belt portion 12 can suppress concentration of a great force on the coupling portion between the pelvis 50 and the backbone of the occupant who has moved forward.

### Example of Movement Mechanism for Inner Buckle

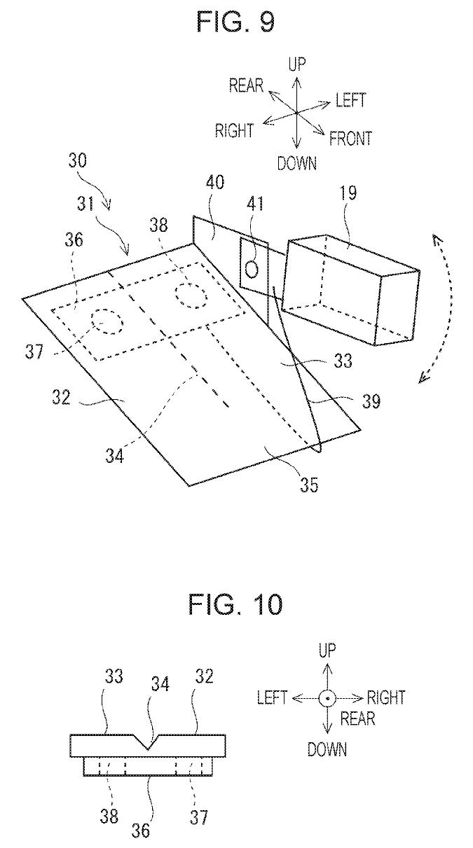

Next, the movement mechanism 30 for fixing the inner buckle 19 to the vehicle body 2 will be described with reference to FIGS. 9 to 12.

The movement mechanism 30 is basically provided to allow the inner buckle 19 to move in the event of a front collision of the vehicle 1 such that the inner buckle 19 does not hinder the rotation of the annular portion 28 of the seat belt 11.

It is preferable that the movement mechanism 30 allow the inner buckle 19 to move when the retractor 15 winds the seat belt 11 by the pre-tension winding operation in the event of a front collision of the vehicle 1, and do not allow the inner buckle 19 to move in the other cases while maintaining the inner buckle 19 at the attachment position. In particular, for example, when the occupant sits on a child safety seat or when a slight front collision occurs at a level at which the retractor 15 does not perform the pre-tension winding operation, it is preferable that the movement mechanism 30 maintain the inner buckle 19 at the attachment position before the movement. Accordingly, it is possible to suppress the movement of the inner buckle 19 when the front collision does not occur.

It is preferable that the movement mechanism 30 move the inner buckle 19 while applying a load, instead of freely moving the inner buckle 19 without applying a load. Thus, the movement mechanism 30 can absorb an impact acting on the occupant.

FIG. 9 is a schematic perspective view illustrating the configuration of an example of the movement mechanism 30 in FIG. 3.

The movement mechanism 30 in FIG. 9 includes a plate 31 fixed to the vehicle body 2, a coupling member 36, and a wire 39.

The plate 31 includes a base portion 32 fixed to the vehicle body 2, a movable portion 33 adjacent to the base portion 32 in the right-left direction, a tearing structure portion 34 between the base portion 32 and the movable portion 33, and a coupling portion 35 that couples a front edge of the base portion 32 and a front edge of the movable portion 33. The plate 31 is formed in a substantially rectangular outer shape.

The plate 31 is fixed to the vehicle body 2 such that the base portion 32 and the movable portion 33 are arranged in the right-left direction of the vehicle 1. The base portion 32 and the movable portion 33 are each formed in a long rectangular shape along the front-rear direction of the vehicle 1.

For example, as illustrated in FIG. 10, the tearing structure portion 34 may be a groove formed in the plate 31 having the substantially rectangular outer shape. FIG. 10 is a rear end view of the plate 31 in FIG. 9. When a force acts to split the base portion 32 and the movable portion 33 in the up-down direction, the groove is torn.

The tearing structure portion 34 is not formed in the coupling portion 35 of the plate 31 having the substantially rectangular outer shape. The coupling portion 35 couples the base portion 32 and the movable portion 33 in a split state.

The inner buckle 19 is fixed, by a support shaft 41, to an attachment portion 40 coupled to the movable portion 33. Thus, the inner buckle 19 is attached to the movable portion 33 of the plate 31. By fixing the base portion 32 to the vehicle body 2, the inner buckle 19 is fixed to the vehicle body 2.

The coupling member 36 is a plate member that couples the base portion 32 and the movable portion 33 across the tearing structure portion 34. The coupling member 36 may be welded to the base portion 32 and the movable portion 33, or may be fitted by press-fitting or the like to protrusions that protrude from the lower surfaces of the base portion 32 and the movable portion 33 as illustrated in FIG. 10. Thus, the coupling member 36 is attached to the plate 31.

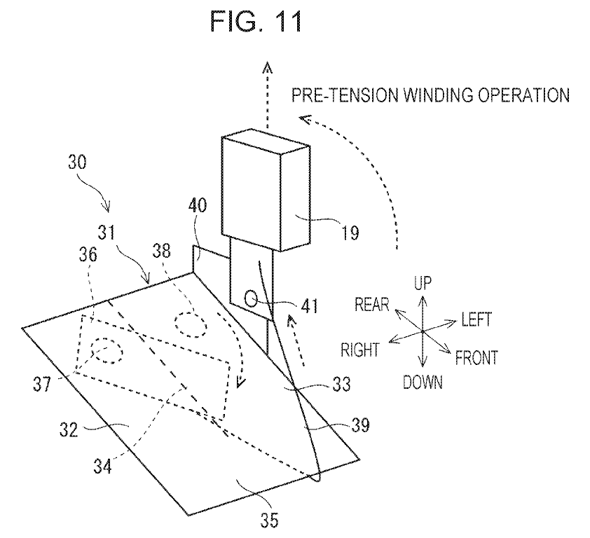

The wire 39 couples the coupling member 36 and the inner buckle 19 via the front side of the plate 31. In FIG. 10, the wire 39 couples the inner buckle 19 and a portion of the coupling member 36 on the movable portion 33 side. In this case, when the inner buckle 19 is pulled upward, the wire 39 pulls forward the coupling member 36 on the movable portion 33 side. When the force of the wire 39 pulling the coupling member 36 forward increases, the coupling member 36 and the movable portion 33 may be decoupled from each other. When the coupling member 36 is decoupled from the movable portion 33, the coupling member 36 may be inclined under the plate 31 as illustrated in FIG. 11.

In the embodiment of the disclosure, the coupling member 36 and the movable portion 33 are set to be decoupled from each other by the force acting on the coupling member 36 from the wire 39 when the retractor 15 winds the seat belt 11 by the pre-tension winding operation to pull the inner buckle 19 upward. When the force for pulling the inner buckle 19 upward is smaller than the decoupling force, the coupling member 36 and the movable portion 33 are not decoupled from each other. For example, when the occupant sits on a child safety seat, the force pulling the inner buckle 19 is equal to or smaller than 50 Kgf. The force of the retractor 15 pulling the inner buckle 19 in the pre-tension winding operation is about 200 Kgf. The coupling member 36 is attached to the plate 31 such that the coupling member 36 is decoupled from the movable portion 33 by a force set therebetween. Thus, the coupling member 36 and the movable portion 33 of the plate 31 are less likely to be decoupled from each other in a daily use environment, and the coupling member 36 and the movable portion 33 of the plate 31 can be decoupled from each other in the event of a front collision that requires the pre-tension winding operation.

FIG. 11 is a schematic perspective view of the movement mechanism 30 in FIG. 9 after the pre-tension winding operation has been performed. In FIG. 11, the retractor 15 winds the seat belt 11 by the pre-tension winding operation. Therefore, the inner buckle 19 is oriented upward, and a force for pulling the inner buckle 19 upward in the upward posture acts strongly. The wire 39 pulls the coupling member 36 forward. Therefore, the coupling member 36 and the movable portion 33 are decoupled from each other. The coupling member 36 assumes an oblique posture under the plate 31. The portion of the coupling member 36 on the movable portion 33 side is located forward of the portion of the coupling member 36 on the base portion 32 side.

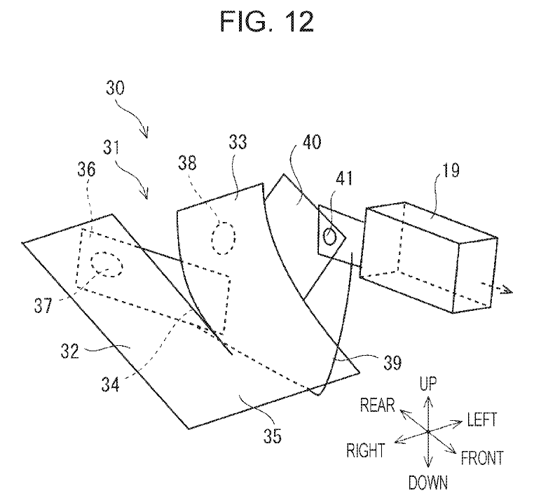

The front collision of the vehicle 1 occurs with the coupling member 36 and the plate 31 decoupled from each other as described above. The occupant sitting in the sitting position 8 of the seat moves forward as illustrated in FIGS. 4 or 7. The annular portion 28 of the seat belt 11 rotates. As illustrated in FIG. 12, the inner buckle 19 included in the annular portion 28 tears the tearing structure portion 34 of the plate 31 and moves forward together with the movable portion 33 of the plate 31. FIG. 12 is a schematic perspective view of the movement mechanism 30 in FIG. 9 after the front collision of the vehicle 1.

When the inner buckle 19 moves forward, the tearing structure portion 34 of the plate 31 is torn. Therefore, the annular portion 28 including the inner buckle 19 can suppress the forward movement of the occupant who moves forward, and can absorb the impact acting on the occupant.

### Example of Occupant Protection by Three-point Seat Belt Device in Comparative Example

Next, a three-point seat belt device in a comparative example will be described for comparison with the embodiment of the disclosure. As the three-point seat belt device in the comparative example, an example in which an inner buckle is directly fixed to a vehicle body will be described. The other configuration of the comparative example may be the same as that of the above embodiment. Hereinafter, in the configuration of the comparative example, the same components as those of the above embodiment are denoted by the same reference numerals, and description thereof will be omitted.

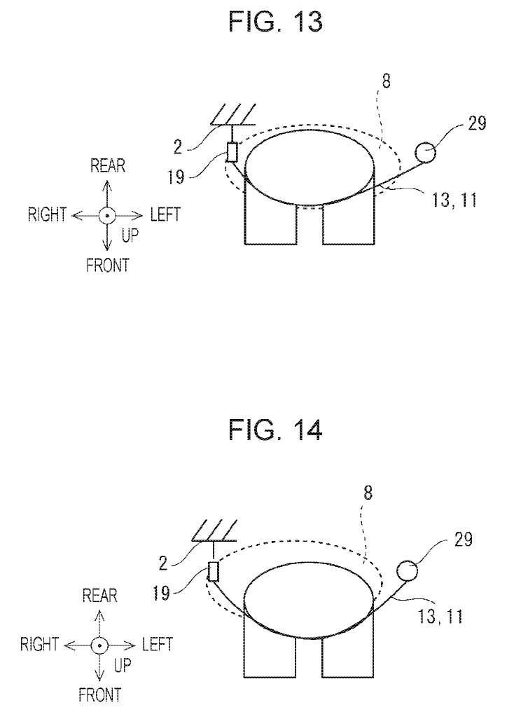

FIG. 13 is a schematic explanatory top view of the occupant in the state before the front collision in the comparative example. As illustrated in FIG. 13, in the three-point seat belt device in the comparative example, the inner buckle 19 is directly attached to the vehicle body 2 on the second side relative to the sitting position 8 of the seat. The second end of the seat belt 11 is attached to the vehicle body 2 at a support point 29 on the first side relative to the sitting position 8 of the seat. In this case, as illustrated in FIG. 15, the shoulder belt portion 12 and the lap belt portion 13 of the seat belt 11 are stretched in front of the occupant wearing the seat belt 11 with the inner tongue 17 coupled to the inner buckle 19. The seat belt 11 in the comparative example does not have the back belt portion 14 or the annular portion 28. FIG. 15 is a schematic explanatory diagram of the occupant in the right sitting position 8 of the rear seat 5 in FIG. 2 in the state before the front collision.

When the vehicle 1 then comes into the front collision, the occupant moves forward as illustrated in FIGS. 14 and 16. FIG. 14 is a schematic explanatory diagram of a state in which the occupant in FIG. 13 has moved forward due to the front collision. FIG. 16 is a schematic explanatory diagram of a state in which the occupant in FIG. 15 has moved forward due to the front collision. When the occupant starts to move forward from the sitting position 8 of the seat, the occupant is supported from the front by the lap belt portion 13 of the seat belt 11 between the inner buckle 19 and the support point 29 of the seat belt 11. Finally, as illustrated in FIG. 14, the occupant moves in the forward and outward direction such that the center of gravity of the occupant comes to the central position between the inner buckle 19 and the support point 29 of the seat belt 11. During this movement, the lap belt portion 13 of the seat belt 11 does not rotate. The body of the occupant slides on the lap belt portion 13 of the seat belt 11. The lap belt portion 13 of the seat belt 11 is likely to be displaced upward or downward in front of the body of the occupant. The inner buckle 19 does not move forward, maintains the position where it is fixed to the vehicle body 2, and stays at the position rearward of the waist of the occupant who moves forward. The distance from the inner buckle 19 to the waist of the occupant who has moved forward increases. If the distance increases, the lap belt portion 13 and the shoulder belt portion 12 of the seat belt 11 are likely to be displaced upward from the position in front of the pelvis 50 of the waist of the occupant. The lap belt portion 13 and the shoulder belt portion 12 of the seat belt 11 may be stretched in front of the abdomen of the upper body of the occupant.

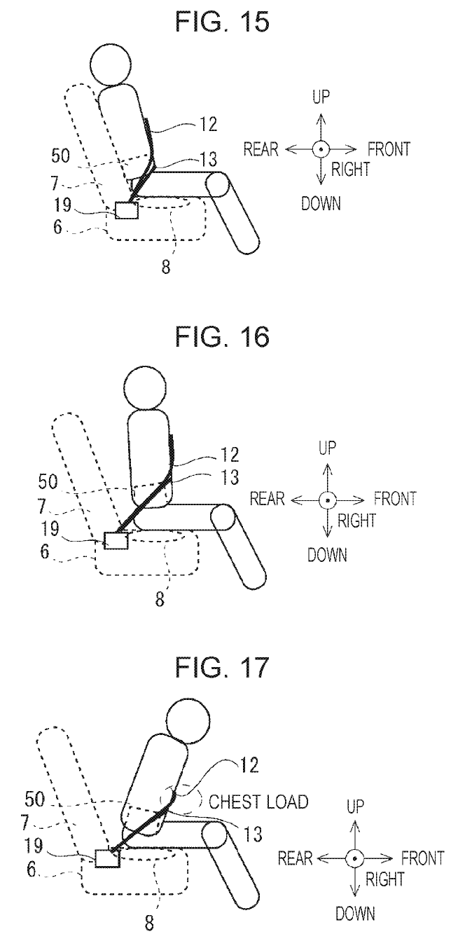

When the upper body of the occupant falls forward as illustrated in FIG. 17 in a state in which the seat belt 11 rides on the pelvis 50 of the waist, a load for moving the occupant forward concentrates on the abdomen of the occupant. The body of the occupant may be in a state in which only the coupling portion between the pelvis 50 and the backbone is supported and the upper body and the waist of the occupant above and below the coupling portion move forward. As a result, a great force may concentrate on the coupling portion between the pelvis 50 and the backbone of the occupant who has moved forward. A load may be applied to the chest of the occupant. FIG. 17 is a schematic explanatory diagram of the state in which the upper body of the occupant in FIG. 15 has fallen forward due to the front collision.

### Effects of Embodiment

As described above, in the embodiment of the disclosure, the three-point seat belt device 10 for the vehicle 1 includes the outer support member 20 and the inner support member 21. The outer support member 20 is attached to the vehicle body 2 at the position that is on the first side relative to the sitting position 8 and is lower than the sitting position 8 of the seat in the rearward and downward direction. The inner support member 21 is attached to the vehicle body 2 at the position that is on the second side relative to the sitting position 8 and is lower than the sitting position 8 of the seat in the rearward and downward direction. The first side relative to the sitting position 8 is the side on which the retractor 15 that winds the first end out of both ends of the seat belt 11 is provided in the right-left direction of the vehicle 1 relative to the sitting position 8 of the seat. The second side is a side opposite to the retractor 15.

The seat belt 11 passes through the tongue hole 18 of the inner tongue 17, behind the outer support member 20, and behind the inner support member 21. The second end out of both ends of the seat belt 11 is fixed to the inner buckle 19. When the inner tongue 17 is coupled to the inner buckle 19, the seat belt 11 has an annular shape around the waist of the occupant sitting in the sitting position 8 of the seat. The outer support member 20 and the inner support member 21 attached to the vehicle body 2 together with the waist of the occupant sitting in the sitting position 8 of the seat are located inward of the annular portion 28. The annular portion 28 includes the lap belt portion 13 of the seat belt 11 that is stretched in front of the waist of the occupant.

When the vehicle 1 comes into a front collision, the occupant sitting in the sitting position 8 of the seat moves forward in the vehicle 1 from the sitting position 8 on the seat. When the occupant moves forward, the annular portion 28 of the seat belt 11 is pulled forward while maintaining the annular shape. When the occupant starts to move forward, the distance from the waist of the occupant to the outer support member 20 and the inner support member 21 increases. Therefore, the load of the occupant acts strongly on the annular portion 28. The annular portion 28 is brought into close contact with the occupant by the load of the occupant, and is strongly pulled in the moving direction of the occupant. Therefore, the annular portion 28 is less likely to be displaced relative to the occupant. As a result, the annular portion 28 of the seat belt 11 can rotate in conjunction with the movement of the occupant. In particular, when the seat belt 11 is pre-tensioned, the annular portion 28 of the seat belt 11 is substantially in close contact with the occupant before the occupant starts to move, and can rotate in conjunction with the movement of the occupant immediately after the occupant starts to move. The annular portion 28 of the seat belt 11 is supported by the outer support member 20 and the inner support member 21 that are attached to the vehicle body 2. Therefore, even when the annular portion 28 is pulled forward by the load of the occupant, the entire annular portion 28 does not move forward. The annular portion 28 can support the occupant who will move forward such that the occupant does not move forward.

As a result, the inner buckle 19 included in the annular portion 28 can be maintained at the position on the inner side of the waist of the occupant relative to the occupant who has moved forward, similarly to the time when the occupant has worn the seat belt 11. In particular, when the occupant is located in the left-end sitting position 8 or the right-end sitting position 8 of the three-seater rear seat 5, the distance from the sitting position 8 of the occupant to the outer support member 20 may be larger than the distance from the sitting position 8 of the occupant to the inner buckle 19. In this case, the occupant may move in a forward and outward direction. Even when the occupant moves in the forward and outward direction, the annular portion 28 of the seat belt 11 is pulled in the forward and outward direction while rotating. As a result, the inner buckle 19 can be maintained at the position on the inner side of the waist of the occupant relative to the occupant who has moved in the forward and outward direction.

Thus, in the embodiment of the disclosure, when the waist of the occupant moves forward, the annular portion 28 of the seat belt 11 around the waist of the occupant may be pulled forward in conjunction with the movement of the waist while rotating. The inner buckle 19 can be maintained at the position on the inner side of the waist that has moved forward similarly to the time when the occupant has worn the seat belt 11. Since the inner buckle 19 is maintained at the position on the inner side of the waist, the seat belt 11, particularly the shoulder belt portion 12 stretched obliquely in front of the upper body of the occupant, is likely to remain stretched in front of the waist of the occupant similarly to the time when the occupant has worn the seat belt 11. Since the perimeter of the annular portion 28 of the seat belt 11 is invariable, the occupant restraining performance is less likely to decrease even when the annular portion 28 rotates.

If the annular portion 28 of the seat belt 11 does not rotate because, for example, the inner buckle 19 is not movable, the annular portion 28 of the seat belt 11 is simply pulled forward without rotating. The inner buckle 19 does not move forward, maintains the original attachment position, and stays at the position rearward of the waist of the occupant who moves forward. As a result, the distance from the inner buckle 19 to the waist increases. If the distance increases, the seat belt 11, particularly the shoulder belt portion 12, is likely to be displaced upward from the position in front of the waist of the occupant when the occupant has worn the seat belt 11. When the shoulder belt portion 12 of the seat belt 11 moves onto the waist and rides on the waist, the input of the shoulder belt portion 12 to the chest of the occupant whose upper body falls forward after the movement is likely to increase.

In the embodiment of the disclosure, as described above, the seat belt 11, particularly the shoulder belt portion 12, is likely to remain stretched in front of the waist of the occupant even when the waist of the occupant moves forward. As a result, in the embodiment of the disclosure, the seat belt 11, particularly the shoulder belt portion 12, is less likely to ride on the waist even when the waist of the occupant moves forward. As a result, in the embodiment of the disclosure, it is possible to reduce the occurrence of the case where the shoulder belt portion 12 or the like of the seat belt 11 rides on the waist of the occupant who has moved forward, and as a result, the input of the shoulder belt portion 12 to the chest of the occupant increases.

In the embodiment of the disclosure, the inner buckle 19 is attached to the vehicle body 2 of the vehicle 1 such that the inner buckle 19 is movable by the movement mechanism 30. The movement mechanism 30 allows the inner buckle 19 to move when the retractor 15 winds the seat belt 11 by the pre-tension winding operation in the event of a front collision of the vehicle 1. Although the annular portion 28 of the seat belt 11 includes the inner buckle 19 attached to the vehicle body 2, the rotation of the annular portion 28 is less likely to be hindered by the inner buckle 19 in the event of the front collision of the vehicle 1. The annular portion 28 of the seat belt 11 can rotate in conjunction with the load of the occupant while moving the inner buckle 19.

In the embodiment of the disclosure, the movement mechanism 30 maintains the inner buckle 19 at a predetermined position and does not allow the inner buckle 19 to move in the state in which the retractor 15 does not perform the pre-tension winding operation. Therefore, the inner buckle 19 does not move in the normal state in which the pre-tension winding operation is not performed. For example, the inner buckle 19 can be prevented from moving when the seat belt 11 is tensioned to fix a child safety seat to the seat. In addition, the inner buckle 19 can be prevented from moving in a slight front collision in which the retractor 15 does not perform the pre-tension winding operation.

In the embodiment of the disclosure, the movement mechanism 30 includes the plate 31 fixed to the vehicle body 2, the coupling member 36 attached to the plate 31, and the wire 39 that couples the coupling member 36 and the inner buckle 19. The plate 31 includes the base portion 32 fixed to the vehicle body 2, the movable portion 33 that is adjacent to the base portion 32 in the right-left direction and to which the inner buckle 19 is attached, the tearing structure portion 34 that splittably couples the base portion 32 and the movable portion 33, and the coupling portion 35 that couples the front edge of the base portion 32 and the front edge of the movable portion 33. The coupling member 36 couples the base portion 32 and the movable portion 33 across the tearing structure portion 34. The wire 39 pulls the coupling member 36 to decouple the coupling member 36 and the movable portion 33 by winding the seat belt 11 and pulling the inner buckle 19 upward through the pre-tension winding operation of the retractor 15 in response to the front collision of the vehicle 1.

Thus, the movement mechanism 30 according to the embodiment of the disclosure can decouple the coupling member 36 and the movable portion 33, tear the tearing structure portion 34 that couples the base portion 32 and the movable portion 33 by the movement of the inner buckle 19, and allow the inner buckle 19 to move in the event of the front collision of the vehicle 1. That is, the movement mechanism 30 allows the inner buckle 19 to move by winding the seat belt 11 through the pre-tension winding operation of the retractor 15 in response to the front collision of the vehicle 1. As a result, when the occupant moves forward, for example, the inner buckle 19 will move forward together with the annular portion 28 of the seat belt 11. By this force, the tearing structure portion 34 is torn, and the inner buckle 19 can move forward. The rotation of the annular portion 28 of the seat belt 11 is less likely to be hindered in the event of the front collision of the vehicle 1. The impact acting on the occupant can be absorbed by tearing the tearing structure portion 34. As a result, an excessive restraining force can be made less likely to act on the body of the occupant while maintaining, for the moving occupant, the positional relationship between the waist of the occupant and the inner buckle 19.

The seat belt 11 is not wound by the pre-tension winding operation of the retractor 15 in the normal state other than the front collision of the vehicle 1. Therefore, the coupling member 36 of the movement mechanism 30 couples the base portion 32 and the movable portion 33 across the tearing structure portion 34. As a result, the inner buckle 19 can be prevented from moving in the normal state other than the front collision of the vehicle 1. For example, it is possible to maintain the state in which the inner buckle 19 does not move in the case of a force for tensioning the belt by the occupant or by hand when attaching a child safety seat. Further, it is possible to maintain the state in which the inner buckle 19 does not move in the event of a slight front collision at a level at which the retractor 15 does not perform the pre-tension winding operation.

Since the inner buckle 19 is attached to the vehicle body 2 by using such a movement mechanism 30, the inner buckle 19 can be normally provided at the predetermined position on the vehicle body 2 relative to the sitting position 8 of the seat. The inner buckle 19 can be provided on the vehicle body 2 at the position on the inner side of the waist of the occupant sitting in the sitting position 8 when the occupant wears the seat belt 11.

Although the above embodiment is an exemplary embodiment of the disclosure, the embodiment of the disclosure is not limited to the above embodiment, and various modifications and alterations may be made without departing from the gist thereof.

### Modifications

In the above embodiment, the movement mechanism 30 for the inner buckle 19 allows the inner buckle 19 to move by tearing the plate 31.

For example, the movement mechanism 30 for the inner buckle 19 may allow the inner buckle 19 to move by a rail fixed to the vehicle body 2 and a slider moving on the rail. The inner buckle 19 is attached to the slider. The rail may be basically provided along the front-rear direction of the vehicle 1. An elastic member may be disposed between the rail and the slider to fill a gap therebetween. The elastic member can absorb an impact by being deformed when the slider moves.

In the movement mechanism 30 for the inner buckle 19 in the above embodiment, the coupling member 36 and the movable portion 33 of the plate 31 are decoupled from each other by pulling the coupling member 36 using the wire 39, thereby switching the movable and immovable states of the inner buckle 19.

For example, in the movement mechanism 30 for the inner buckle 19, a sensor may detect the front collision of the vehicle 1 or the pre-tension winding operation of the retractor 15, and the actuator 16 that acquires information on the detection of the sensor may decouple the coupling member 36 and the movable portion 33 of the plate 31.

In the embodiment of the disclosure, when the vehicle comes into a front collision, the occupant sitting in the sitting position of the seat moves forward in the vehicle from the sitting position on the seat. When the load of the occupant acts, the annular portion of the seat belt rotates in conjunction with the movement of the occupant. As a result, the inner buckle included in the annular portion can be maintained at the position near the waist of the occupant relative to the occupant who has moved forward. The inner buckle can be maintained at the position near the waist of the occupant who has moved forward similarly to the time when the occupant has worn the seat belt. The annular portion of the seat belt is supported by the outer support member and the inner support member. Therefore, even when the annular portion is pulled forward by the load of the occupant, the entire annular portion does not move forward. The annular portion can support the occupant who will move forward such that the occupant does not move forward. Since the inner buckle is maintained at the position near the side of the waist of the occupant who has moved forward, the seat belt is likely to remain stretched in front of the waist of the occupant in the same state as that when the occupant has worn the seat belt. Even if the occupant moves in the event of the front collision of the vehicle, the wearing state of the seat belt relative to the occupant is less likely to change from the state when the occupant has worn the seat belt.

As a result, in the embodiment of the disclosure, the shoulder belt portion or the like of the seat belt that is stretched obliquely in front of the upper body of the occupant is less likely to ride on the waist of the occupant who has moved forward. The input to the chest of the occupant who will fall further forward from the state in which the occupant has moved forward is borne by the shoulder belt portion or the like that is stretched in the same state as that when the occupant has worn the seat belt. As a result, the input to the chest of the occupant whose upper body falls forward after the movement can be less unlikely to increase.

1. A three-point seat belt device for a vehicle, the three-point seat belt device comprising:
a seat belt configured to be stretched in front of an occupant sitting in a sitting position of a seat of the vehicle;
a retractor that is provided on a first side out of left and right sides of the vehicle relative to the sitting position of the seat and is configured to wind a first end out of ends of the seat belt;
an inner tongue having a tongue hole;
an inner buckle detachably coupled to the inner tongue;
an outer support member fixed at a position that is on the first side relative to the sitting position and is lower than the sitting position of the seat; and
an inner support member fixed at a position that is on a second side out of the left and right sides of the vehicle relative to the sitting position and is lower than the sitting position of the seat, wherein
the seat belt passes through the tongue hole of the inner tongue, behind the outer support member, and behind the inner support member,
a second end out of the ends of the seat belt is fixed to the inner buckle,
the seat belt is configured to, when the inner tongue is coupled to the inner buckle, form an annular portion that is annular around a waist of the occupant sitting in the sitting position of the seat between the inner buckle and the outer support member, and
the outer support member and the inner support member are located inward of the annular portion.

2. The three-point seat belt device for the vehicle according to claim 1, further comprising
a movement mechanism that is provided on the second side out of both the left and right sides of the vehicle relative to the sitting position and supports the inner buckle such that the inner buckle is movable relative to a vehicle body of the vehicle on the second side relative to the sitting position.

3. The three-point seat belt device for the vehicle according to claim 2, wherein
the movement mechanism is configured to
allow the inner buckle to move when the retractor winds the seat belt by a pre-tension winding operation, and
prohibit the inner buckle from moving in a state in which the retractor does not perform the pre-tension winding operation.

4. The three-point seat belt device for the vehicle according to claim 3, wherein
the movement mechanism comprises:
a plate fixed to the vehicle body;
a coupling member attached to the plate; and
a wire that couples the coupling member and the inner buckle,
the plate comprises a base portion fixed to the vehicle body, a movable portion that is adjacent to the base portion in a right-left direction of the vehicle and to which the inner buckle is attached, a tearing structure portion that splittably couples the base portion and the movable portion, and a coupling portion that couples a front edge of the base portion and a front edge of the movable portion,
the coupling member couples the base portion and the movable portion across the tearing structure portion, and
the wire is configured to pull the coupling member to decouple the coupling member and the movable portion when the retractor winds the seat belt and pulls the inner buckle upward in response to a front collision of the vehicle.
